(19) United States
(12) Patent Application Publication
(10) Pub. No.: US 2019/0098423 A1
(43) Pub. Date: Mar. 28, 2019

(54) ACOUSTIC MEMBRANE

(71) Applicant: ISOVOLTA AG, Wiener Neudorf (AT)

(72) Inventors: Christian Zechner, Grobming (AT); Peter Pertl, Graz (AT); Christian Bertl, Bad Gleichenberg (AT)

(21) Appl. No.: 16/096,935

(22) PCT Filed: Apr. 25, 2017
(86) PCT No.: PCT/EP2017/059814

§ 371 Date: Oct. 26, 2018

(30) Foreign Application Priority Data
Apr. 26, 2016 (EP) 16167084.9

(51) Int. Cl. H04R 31/00; H04R 7/10; H04R 1/28

(52) U.S. Cl. CPC H04R 31/003; H04R 2307/025; H04R 1/288; H04R 7/10

(57) ABSTRACT

Acoustic membrane (100) comprising at least three layers with a first outer layer (101) and a second outer layer (102), wherein the first and the second outer layer (101, 102) are formed by a thermoplastic elastomer, wherein the thermoplastic elastomer forming the first outer layer and the thermoplastic elastomer forming the second outer layer are independently from each other selected from the group consisting of polyester elastomers, co-polyester elastomers, styrene block copolymers, elastic co-polyamides, thermoplastic silicones, and elastomeric polyolefins, preferably co-polyester elastomers.

The present invention relates to an acoustic membrane with a first outer layer and a second outer layer, and an acoustic device comprising such an acoustic membrane.

Electromagnetic transducers are used for various types of loudspeakers and microphones, in particular also for miniature loudspeakers as applied in mobile phones, notebooks, tablets, gaming consoles, earphones, hands-free speakerphones, modern televisions and also in the automotive sector.

A general market trend shows that the structural shape of such loudspeakers does not allow a uniform design and demands great flexibility from manufacturers. In addition, smallest structural shapes with maximum performance are often demanded. Nevertheless, highest requirements are placed on the acoustic quality. All those requirements impose tremendous technological demands on the membrane, which functions as the centerpiece of a loudspeaker or microphone, respectively.

In order to meet those requirements, manufacturers of miniature loudspeakers employ multifunctional layered films as diaphragm materials, also called acoustic membranes.

EP 2 268 058 discloses use of elastic membranes (i.e. Young's modulus below 100 MPa) for speaker membranes.

WO 2015/052316 discloses membranes for acoustic devices comprising thermoplastic elastomers generated by extrusion. Also methods for generation of multilayer arrangements are disclosed wherein at least one layer is a thermoplastic elastomer and another layer a chemically different thermoplastic material.

WO 2014/13562 discloses five-layered membranes wherein thermoplastic elastomers are suggested as glue layers below the surface forming layers.

WO 2008/056286 discloses a multilayer membrane for acoustic devices, wherein thermoplastic materials are used. The surface facing external membranes are preferably softer materials that can be melted and used to build a direct connection to other components of the acoustic device. Preferably, one layer is rigid, e.g. polycarbonate, and another layer is of a softer material, e.g. PU. Thermoplastic elastomers are considered particularly appropriate.

DE 10 2008 010298 discloses membranes with three layers for acoustic devices, wherein the outer material is a polyimide, i.e. PEI, and the central layer is a PET film or PBT film. It is discussed that PEI is preferred as outer material due to a higher glass transition temperature compared to the material of the central layer which results in increased thermal resistance.

US 2015/0312660 discloses a multilayer arrangement with three layers, wherein a middle layer of an adhesive material is embedded in two layers of thermoplastic material differing from each other. Exemplarily PEEK and PEI are disclosed as outer material. The three layers and asymmetric composition are considered beneficial over 5-layered symmetric arrangement.

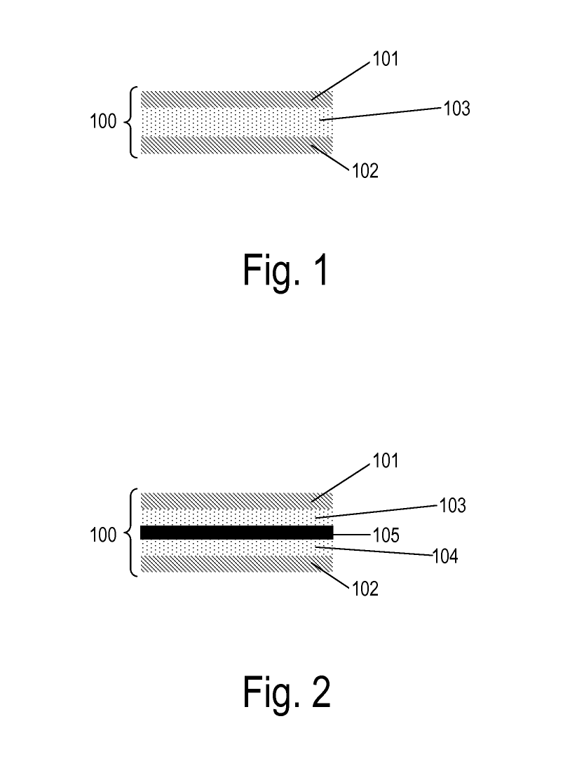

WO 2015/180289 discloses multi-layer arrangements, wherein at least one of the so called surface layers has two layers: a base layer being PEEK, a polyarylester, PET, PEI and a reinforcement layer being thermoplastic polyurethane elastomer or thermoplastic elastomer. In one of the drawings (FIG. 1), the elastomeric reinforcement layer forms an external part of the arrangement. The middle layer is an adhesive e.g. an acrylic adhesive material.

WO 2015/027715 proposes acoustic membranes with a three layer arrangement, wherein the external PEEK layers differ from each other by being either amorphous PEEK or crystalline PEEK. The central layer may be PU.

CN 103738020 discloses a vibrating diaphragm, wherein a specific silica gel system is disclosed to form an adhesive layer between two layers of polymer material such as PEEK, PEN, PA, PC.

CN 202652511 discloses a five-layer membrane. A central PET layer is laminated within two layers of acrylic gel and followed by outer polymer layers on each side. PEI, PEN, PEEK and PPS are disclosed as materials for the outer polymer layers.

CN 203446015 discloses a composite vibrating membrane with a central base layer that is a PET material, e.g. PBT covered on one side with a polyether ether ketone (PEEK) layer and on the other one with a thermoplastic polyurethane (TPU) layer. In an embodiment with five layers, two glue layers intervene between the base layer and the surface layers.

However, especially in the field of miniature applications handling of the small membrane component and material failure of the acoustic membrane are an issue. Alternative robust membranes with materials that allow cheap production are required. Especially PEEK, which is a preferred material in established acoustic composite membranes, has high material costs.

### DESCRIPTION OF THE INVENTION

The present invention provides an acoustic membrane comprising at least three layers with a first outer layer and a second outer layer characterized in that the first and the second outer layer are formed by a thermoplastic elastomer, wherein the thermoplastic elastomer forming the first outer layer and the thermoplastic elastomer forming the second outer layer are independently from each other selected from the group consisting of polyester elastomers, co-polyester elastomers, styrene block copolymers, elastic co-polyamides, thermoplastic silicones, and elastomeric polyolefins, preferably co-polyester elastomers.

The inventors surprisingly found that by using a thermoplastic elastomer as outer layer life time until fracture under cyclic loads may be increased (more than 10⁶ cycles to failure during characterization of fatigue behaviour simulating superficial damage). Without wishing to be bound by theory, on one hand the reason for the observation may be that crack propagation and crack growth is reduced by the elastic outer layers compared to state of the art membranes with outer layers from thermoplastic materials that are less elastic, such as e.g. PEEK or PEI. On the other hand, it is believed that the elastic outer layer protects against superficial damages and thus prohibits crack initiation, e.g. during processing and construction of an acoustic device. In consequence the acoustic membrane according to the invention has a higher life time.

Another advantage of the elastic outer layers in a multi-layer arrangement (i.e. thermoplastic elastomers as outer layer in combination with a harder polymer layer in the centre and a damping material in between of the outer layers and the centre layer) is increased damping compared to an elastic mono-layer membrane film. Good damping properties improve the sound behaviour of acoustic devices with membranes according to the invention.

The term “acoustic membrane” should be understood as a synonym for a film or layered structure that may be used as oscillatory component in a loudspeaker diaphragm or a microphone diaphragm. As specified, the acoustic membrane according to the invention is a multi-layered membrane comprising at least three layers. The superposed layers extend essentially over the same areas. The area formed by the membrane, i.e. the two-dimensional extension of the membrane as such may be variable. The height or thickness of the membrane is defined by the contributions of the involved layers.

The term “outer layer” defines those layers that are surface exposed i.e. surface forming. The outer layers form either the upper side or the lower side of the acoustic membrane. These layers form the external part of the membrane. Alternatively they may be referred to as top coat or coating. In contrast, inner layers are in direct contact with the neighbouring layers on their upper and lower side. Inner layers face the surroundings only on the margins of the membrane.

The term “thermoplastic elastomer” refers to materials combining the properties of thermoplastic and elastic materials. Thus, as rubbers they show a high elasticity and as thermoplastic polymers they may be melted reversibly. The term TPE is often used to refer to thermoplastic elastomers.

Use of thermoplastic elastomers has advantages over the use of other rubber or silicone materials. The inventors of the present invention previously developed a method for producing membranes for acoustic applications, wherein the thermoplastic elastomer is shaped to a film by extrusion (WO 2015/052316). Also the production of multi-layered membranes according to the present invention can be achieved by co-extrusion. Thus, an economic production method for the acoustic membranes according to the invention is available.

According to the present invention, the outer layers are formed by a thermoplastic material with properties of an elastomer, i.e. selected from each other selected from the group consisting of polyester elastomers, co-polyester elastomers, styrene block copolymers, elastic co-polyamides, thermoplastic silicones, and elastomeric polyolefins. Thus, the outer layer material is more elastic than other thermoplastic materials used in acoustic membranes such as PAEK (polyaryletherketone), e.g. PEEK (polyether ether ketone), PEI (polyether imide), PAR (polyarylate), modified PAR types, PC (polycarbonate), PA (polyamide), PET (polyethylene terephthalate), PEN (polyethylene naphthalate), PPSU (polyphenylsulfone), PES (polyethersulfone) and PSU (polysulfone). Quantitatively elasticity may be determined by Young's modulus. Thermoplastic elastomers suitable for the outer layers of an acoustic membrane according to the invention have low Young's modulus.

In one embodiment, the acoustic membrane according to the invention is characterized in that at least one of the first and second outer layer are formed by a thermoplastic elastomer having a Young's modulus below 500 MPa, preferably below 200 MPa.

According this embodiment the Young's modulus may be measured according to EN ISO 527. Thermoplastic elastomers with a Young's modulus below 500 MPa, preferably below 200 MPa are preferred as to form the outer layers, wherein the Young's modulus is measured at room temperature. Also thermoplastic elastomers having a Young's modulus of below 100 MPa or even below 20 MPa may be applied. Alternatively, the thermoplastic elastomer may be characterized by durometer hardness which should be below 70 Shore D.

Suitable thermoplastic elastomers are polyester elastomers, co-polyester elastomers, styrene block copolymers like SBS (styrene-butadiene block copolymer) or SEBS (styrene-ethylene-butylene-styrene block copolymer), elastic co-polyamides, thermoplastic silicones, and elastomeric polyolefins. Especially, materials selected from the group consisting of polyester elastomers and thermoplastic co-polyesters are found suitable. The terms TPC or TPE-E are used to summarize polyester elastomers and thermoplastic co-polyesters.

TPC materials outperform polyurethanes in terms of mechanical durability and good ageing properties. Especially ageing behaviour of the TPC materials is desirable for the membranes according to the invention because of the increased lifetime performance in comparison to other multi-layer membranes.

In a preferred embodiment, the acoustic membrane according to the invention is characterized in that the first outer layer and the second outer layer are formed by the same thermoplastic elastomer.

In view of easier manufacturing of the membranes and further processing for acoustic devices, symmetrical arrangements may be preferred. Mechanical protection is desired on both sides of the membrane. Thus, a symmetrical arrangement is preferred, wherein both outer layers are of the same material.

In one embodiment the acoustic membrane according to the invention is characterized in that at least one damping layer intervenes between the first and the second outer layer. The damping layer preferably is an elastomeric material or a rubber such as a material selected out of the group consisting of acrylic material, silicone material and polybutadiene rubber.

A damping layer is of a material that allows mechanical damping. Mechanical damping refers to the fact that the membrane might show some failure modes especially around the membrane's resonance frequency. A damping layer may reduce undesired failure modes. The damping layer is preferably formed by a soft and elastic material. Suitable synthetic rubber materials are preferred such as acrylic material, silicone material or polybutadiene rubber. Preferably, the damping material has a high mechanical loss. The proposed acrylic or silicone materials may also serve as glue layer to connect the individual layers of the acoustic membrane. Acrylic material is preferred for the damping layer due to excellent damping properties for acoustical applications.

Different inner arrangements of the membrane according to the invention have been investigated by the inventors. If one single damping layer intervenes between the first and the second outer layer, the membrane according to the invention is a three-layered membrane. Exemplarily, three-layer membrane may be composed of a first outer layer being a thermoplastic elastomer like TPC, an internal layer being an acrylic material for damping and a second outer layer being the same thermoplastic elastomer as the first outer layer.

Alternatively also five-layer membranes have been investigated. As in the three layer membranes described above, each of the outer layers is in direct contact with a damping layer being an elastic material preferably selected out of the group consisting acrylic material, silicone material and polybutadiene rubber. Additionally, a central reinforcement layer separates two damping layers.

Thus, in one embodiment of the invention, the membrane comprises five layers, wherein the central layer is a reinforcement layer and a first damping layer and a second damping layer intervene between the reinforcement layer and the first and second outer layer, respectively.

Preferably, the central layer is made out of a material having a higher Young's modulus as the outer layers. The material of the central layer is for example a thermoplastic material such as PAEK, PEI, PAR, modified PAR, PPSU, PSU, PES, PET, PEN, PA, PC, preferably PEEK.

Moreover, in a five-layer membrane it may be preferred that the first and second outer layers are made from a TPC material and the first and the second damping layers are an acrylic material.

Thermal formability of thermoplastic materials (like e.g. PEEK) is a big advantage for designing acoustic membranes and the proposed materials allow that the complete acoustic membrane according to the invention may be formed by a heat-based method. Material characteristics of PEEK provide that the composite membrane has excellent properties. In a five-layered arrangement according to the present invention, the advantages of a thermoplastic reinforcement layer can be used while the largest and surface exposed parts of the membrane, i.e. the outer layers are formed by a thermoplastic material with protective behaviour and preferably cheaper basic material. Moreover, it was found that composite membranes according to this embodiment achieve similar or elongated life times while the fraction of PEEK may be reduced in comparison to membranes with PEEK as outer layers. The protective thermoplastic elastomers seem to form synergies with the stiffer core-layers. Alternative materials used for the reinforcement layer, e.g. PAR, may achieve similar results as PEEK laminates.

In another aspect, the invention provides an acoustic device comprising a membrane according to the invention. Exemplary, the acoustic device may be an electro dynamic acoustic transducer. The acoustic device may comprise a transducer element and a coil, wherein the coil is coupled to the oscillating membrane according to the invention. Optionally the acoustic device may further comprise a base member and/or a cover member.

An acoustic device is a loudspeaker or a microphone, in particular also for a miniature loudspeaker as applied in mobile phones, notebooks, tablets, gaming consoles, earphones, hands-free speakerphones, modern televisions and also in the automotive sector.

The acoustic device according to the invention may be a miniature application, wherein the area formed by the membrane according to the invention is smaller than 10 cm², for example the area of the acoustic membrane may be smaller than 5 cm².

### DETAILED DESCRIPTION OF THE INVENTION

In the following the membrane according to the invention is described in detail with illustrative figures and examples that should not be considered as limiting the invention.

FIG. 1 shows a scheme of a laminate for an acoustic membrane according to the invention with a three-layer arrangement.

FIG. 2 shows a scheme of a laminate for an acoustic membrane according to the invention with a five-layer arrangement.

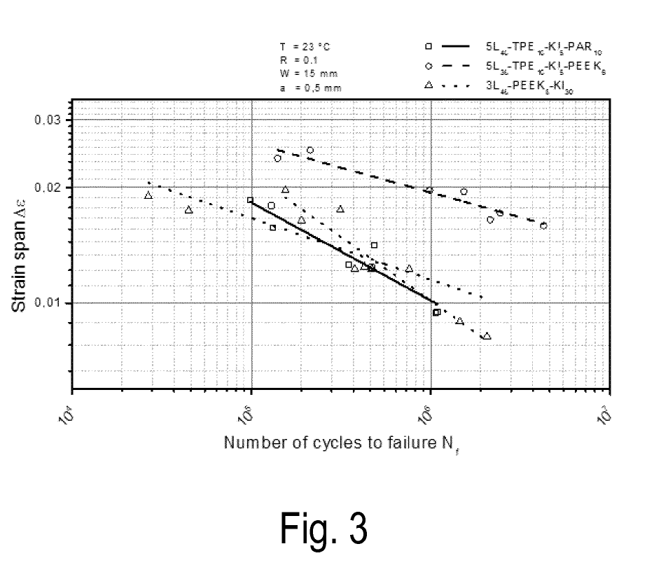

FIG. 3 shows fatigue behaviour of two membranes according to the invention in comparison to a state of the art membrane with PEEK as outer layer.

### EXAMPLES

Production of a Membrane According to the Invention

As described above all materials may be thermoformable, thus, each layer may be produced by extrusion in some embodiments of the multi-layer membrane according to the invention. The inventors found that a membrane according to the invention may be produced by co-extrusion. A method to produce a membrane according to the invention is described in WO 2015/052316.

Three-Layer Membrane Arrangement

FIG. 1 shows a schematic view of a three-layer laminate for a membrane 100 according to the invention having three layers 101, 102 and 103. The upper outer layer 101 and the lower outer layer 102 are formed by a thermoplastic elastomer. The middle layer is a damping layer 103. Preferably, the outer layers 101 and 102 are formed by the identical material and the upper and lower side of the membrane 100 do not differ from each other. In one embodiment the outer layers 101 and 102 may be formed by TPC and the damping layer 103 may be an acrylic polymer.

A three-layer membrane has improved damping behaviour. The damping layer material may also act as glue to connect the outer layers. The three-layer composition may have a thickness of 20 to 100 μm or thicker, for example around 30 μm. The individual layers may contribute similarly to the thickness of the membrane.

Reinforced Five-Layer Membrane Arrangement

FIG. 2 shows a schematic view of a five-layer laminate for a membrane 100 according to the invention. In the arrangement comprising five layers, the central layer 105 may be a PAR layer or a PEEK layer embedded between two damping layers 103 and 104 of acrylics or silicones and the two outer layers 101 and 102 being a thermoplastic elastomer like a TPC.

For example the central reinforcement layer may be 0.5 to 20 μm, for example 6 or 10 μm. The two damping layers may be 4 to 30 μm each, for example 5 μm of an acrylic material. The outer layers may be 5 to 50 μm each, such as for example 10 μm of a TPC material. In summary, the five-layer arrangement may have a thickness of about 20 μm upwards, preferably 30 to 50 μm.

The investigated embodiments of the invention show for example the following arrangements, wherein thickness and material of each layer are as indicated:

TABLE 1

| Layer | Embodiment 1 | | Embodiment 2 | | Embodiment 3 | |
|---|---|---|---|---|---|---|
| (Reference in | (5L₃₆-TPE₁₀-Kl₅- | | (5L₄₀-TPE₁₀-Kl₅- | | (5L₄₂-TPE₁₀-Kl₉- | |
| FIG. 2) | PEEK₆) | | PAR₁₀) | | PEEK₄) | |
| Outer layer | 10 μm | TPC | 10 μm | TPC | 10 μm | TPC |
| (101) | | | | | | |
| Damping layer | 5 μm | Acrylic | 5 μm | Acrylic | 9 μm | Acrylic |
| (103) | | glue | | glue | | glue |
| Reinforcement | 6 μm | PEEK | 10 μm | PAR | 4 μm | PEEK |
| layer (105) | | | | | | |
| Damping layer | 5 μm | Acrylic | 5 μm | Acrylic | 9 μm | Acrylic |
| (104) | | glue | | glue | | glue |
| Outer layer | 10 μm | TPC | 10 μm | TPC | 10 μm | TPC |
| (102) | | | | | | |

In these embodiments, the TPC is a block-copolymer out of polybutyleneterephthalate with glycol. The acrylic material is a soft material with a high internal mechanical loss.

Characterization of the Fatigue Behaviour

Fatigue behaviour was investigated with the dynamic examination machine Electro Force 3230 (Bose Corporation, Eden Prairie, USA), after simulating superficial damage of the membranes. Embodiments 1 and 2 of five-layer membranes according to the invention (see Table 1) were compared with a three-layer membrane according to the state of the art (3L₄₆-PEEK₈-Kl₃₀). The state of the art membrane is composed of two 8 μm layers of PEEK separated by a damping layer of 30 μm. For each investigated membrane embodiment, test strips of 15 mm carved on both sides with 0.5 mm were used and the experiments repeated three times. Clamping length was 45 mm and testing frequency was 100 Hz at 23° C.

In FIG. 3 results of embodiment 1 (5L₃₆-TPE₁₀-Kl₅-PEEK₆) are indicated by circles and dashed line, of embodiment 2 (5L₄₀-TPE₁₀-Kl₅-PAR₁₀) by squares and continues line, and of the comparative example (3L₄₆-PEEK₈-Kl₃₀) by triangles and dotted line.

FIG. 3 shows the strain span after 10 000 cycles. Fatigue strength is similar in all three membranes before failure. The embodiments according to the invention show a higher number of cycles before failure indicating slower crack propagation.

In the praxis however, there can be further essential differences in the cracking mechanics between the multilayer membrane according to the invention and a conventional membrane. Due to the distinct material behaviour of the thermoplastic elastomers in comparison to standard thermoplastics like PEEK, the crack initiation in the outer elastic outer layer may be prevented in membranes according to the invention.

Characterization of the Acoustic Behaviour

The acoustic behaviour was characterized using a system by Klippel (Klippel GmbH, Dresden, Germany) with a tool for micro suspension part measurement (MSPM). A five-layered embodiment according to the invention (embodiment 3 as in Table 1) was compared with a mono-layer. The mono-layer has a single layer of the same TPC material as the outer layers of embodiment 3 and has the same overall thickness of 42 μm.

The method allows characterizing certain parameters after passively exciting a membrane in a pressure chamber using a laser for registering the displacement and a microphone for registering the pressure (microphone sensitivity 12.43 mV/Pa). Results are calculated by mass perturbation and fitting the transfer function. The fitting range was set between 20 to 500 Hz.

Test parameters were similar for both investigated membranes (Table 2).

TABLE 2

| | | | Comparative |
|---|---|---|---|
| Operation | Parameter (unit) | Embodiment 3 | Example |
| With mass | x peak (mm) | 0.048 | 0.049 |
| | SNR (dB) | 32.83 | 33.43 |
| | Max. SPL (dB) | 99.19 | 98.24 |
| No mass | x peak (mm) | 0.048 | 0.047 |
| | SNR (dB) | 24.86 | 29.36 |
| | Max. SPL (dB) | 99.08 | 97.09 |

The results indicate that the embodiment according to the invention and the comparative mono-layer have the same moving mass and the same resonance frequency (Table 3). The mechanical quality factor Q is lower for the membrane according to the invention. This later factor indicates a higher damping and thus, reduction of undesired acoustic effects.

TABLE 3

| | | | Comparative |
|---|---|---|---|
| Result Parameter | Unit | Embodiment 3 | Example |
| Resonance Frequency f_{Reso} | Hz | 247.9 | 247.5 |
| Quality Factor Q | — | 6.064 | 8.512 |
| Moving Mass m | g | 0.04 | 0.04 |
| Mechanical Compliance C | mm/N | 10.4 | 10.34 |
| Stiffness K | N/mm | 0.096 | 0.097 |
| Mechanical Resistance R | kg/s | 0.01 | 0.007 |

1. An acoustic membrane comprising at least three layers with a first outer layer and a second outer layer characterized in that the first and the second outer layer are formed by a thermoplastic elastomer, wherein the thermoplastic elastomer forming the first outer layer and the thermoplastic elastomer forming the second outer layer are independently from each other selected from the group consisting of polyester elastomers, co-polyester elastomers, styrene block copolymers, elastic co-polyamides, thermoplastic silicones, and elastomeric polyolefins, preferably co-polyester elastomers.

2. An acoustic membrane according to claim 1 characterized in that at least one of the first and second outer layer are formed by a thermoplastic elastomer having a Young's modulus below 500 MPa.

3. An acoustic membrane according to claim 1 characterized in that the first outer layer and the second outer layer are formed by the same thermoplastic elastomer.

4. An acoustic membrane according to claim 1 characterized in that at least one damping layer intervenes between the first and the second outer layer.

5. An acoustic membrane according to claim 4, wherein the at least one damping layer is formed by an elastic material.

6. An acoustic membrane according to claim 4, characterized in that the membrane comprises three layers.

7. An acoustic membrane according to claim 4, characterized in that one damping layer of an acrylic material intervenes between the first and second outer layer and wherein the outer layers are formed by a polyester elastomer or co-polyester elastomer.

8. An acoustic membrane according to claim 1, characterized in that the membrane comprises five layers, wherein the central layer is a reinforcement layer and a first damping layer and a second damping layer intervene between the reinforcement layer and the first and second outer layer, respectively.

9. An acoustic membrane according to claim 8, characterized in that the reinforcement layer is formed by a thermoplastic material, preferably selected from the group consisting of PAEK (polyaryletherketone), like PEEK (polyether ether ketone), PEI (polyether imide), PAR (polyarylate), modified PAR types, PC (polycarbonate), PA (polyamide), PET (polyethylene terephthalate), PEN (polyethylene naphthalate), PPSU (polyphenylsulfone), PES (polyethersulfone) and PSU (polysulfone), preferably PEEK.

10. An acoustic membrane according to claim 8, characterized in that the first and second outer layers are formed by a polyester elastomer or co-polyester elastomer, and the first damping layer and the second damping layers are formed by an acrylic or silicone material.

11. An acoustic device comprising an acoustic membrane according to claim 1.

12. An acoustic device according to claim 11, wherein the acoustic device further comprises a transducer element and a coil.

13. An acoustic membrane according to claim 1 characterized in that at least one of the first and second outer layer are formed by a thermoplastic elastomer having a Young's modulus below 200 MPa.

14. An acoustic membrane according to claim 5, wherein the at least one damping layer is formed by an elastic material selected from the group consisting of acrylic material, silicone material, and polybutadiene rubber.

15. An acoustic membrane according to claim 7, characterized in that the outer layers are formed by a co-polyester elastomer.

16. An acoustic membrane according to claim 10, characterized in that the first and second outer layers are formed by a co-polyester elastomer.
